(19) United States
(12) Patent Application Publication
(10) Pub. No.: US 2014/0318376 A1
(43) Pub. Date: Oct. 30, 2014

(54) DEVICE FOR SEPARATING SUBSTANCES FROM A MEDIUM

(71) Applicant: A TEC Holding GmbH, Krems an der Donau (AT)

(72) Inventors: Hans Tillian, Hermagor (AT); Harald Durstberger, Wallisellen (CH)

(21) Appl. No.: 14/127,006

(22) PCT Filed: Apr. 18, 2013
(86) PCT No.: PCT/AT2013/000077

§ 371 Date: Dec. 17, 2013

(30) Foreign Application Priority Data
May 24, 2012 (AT) A 609/2012

(51) Int. Cl. B01D 19/00

(52) U.S. Cl. CPC B01D 19/0052
USPC 96/216

(57) ABSTRACT

A device for separating at least one substance from a liquid or gaseous medium by centrifugal forces has a housing with a separating chamber, into which the mixture to be separated is delivered and is set into rotation. Two immersion tubes, through which cleaned medium flows out, project into the separating chamber. On the lower end of the housing, there is a discharge opening for the separated substance. Between ends of the immersion tubes, within the chamber, there is a diffuser connected to the immersion tubes. The diffuser includes several curved guide vanes that, viewed in the direction of rotation of the medium, have a spacing increasing from the peripheral surface of the immersion tubes, that approach the axis of the immersion tubes. In the diffuser, there are optionally plates, which ensure a laminar flow of the cleaned medium through the immersion tubes and out of the device.

The invention relates to a device for separating at least one substance from a liquid or gaseous medium by centrifugal forces, the substance having a specific weight that is different from the medium, with a housing, with systems for producing the rotary motion of the mixture of the substance and medium around the axis of the housing, with a separating chamber into which immersion tubes project, the medium being withdrawn from the separating chamber through the immersion tubes, and with a discharge opening for the separated substance.

A device with the features of the preamble of the independent claim 1 is known from DE-A 25 12 104 or EP 0 398 864 B.

In these known devices, there are immersion tubes that project into the separating chamber for the discharge of the medium from which the substance or substances to be separated have been at least partially, preferably entirely, removed.

EP-A 398 864 also discloses providing a channeling system in the form of baffle plates between the immersion tubes.

The prior art (for example, AT-PS 13036, GB-PS 245 636) furthermore discloses channeling systems on immersion tubes that have baffle plates that, however, are curved solely around one axis that is aligned parallel to the axis of the immersion tubes. This yields an exclusively radial acceleration that, however, contributes nothing to the overflow of the medium into the immersion tubes.

Furthermore, the prior art discloses propeller-like channeling systems with several vanes on the entry end of the immersion tube, the individual vanes being directed such that they are intended to reduce or completely eliminate the rotary motion of the medium that is entering the immersion tube. In practice, however, these embodiments have not prevailed due to flow engineering problems. The reason for this is that the actual flows in the region of the mouth of the immersion tube are not known.

Devices for separating mixtures of substances under the action of centrifugal forces that have immersion tubes are also known from DE 28 32 097 A, DE 29 45 951 A, and DE 36 15 747 A.

AT 395 385 and EP 0 560 863 B that corresponds to it disclose channeling systems that are located on the ends of immersion tubes, which ends are provided within the separating chambers, and which systems encompasses baffle plates that are curved essentially in the manner of a truncated cone. In this known embodiment of channeling systems on immersion tubes, these channeling systems are made separately for each of the two immersion tubes.

The object of the invention is to devise a device for centrifugal separation, i.e., especially for separation of dust or other solids or of liquids from gases or liquids, quite generally for separation of specifically heavier (liquid or solid) portions (substances) from a liquid or gaseous medium, the substance and the medium being essentially immiscible or insoluble in one another, which can be carried out with low energy consumption and a higher degree of separation.

According to the invention, this is done with a device that has the features of claim 1.

The dependent claims relate to advantageous and preferred further developments of the invention.

The advantages of the device according to the invention arise essentially in that between the immersion tubes, there is a diffuser that physically joins the immersion tubes to one another.

In one embodiment, it can be provided that there are swirl breakers in the diffuser for relamination of the flow in the device.

The device according to the invention is characterized in that compared to conical diffusers, as are known from EP 0 398 864 B, or channeling systems according to EP 0 560 863 B1, it works with lower pressure loss.

Another advantage of the device according to the invention is that the diffuser can be installed in different positions so that it can be provided in the position that is optimum for the respective separation task.

Furthermore, under certain process conditions, the invention yields improved action (separating action) essentially by the cleaned medium, for example clean gas, being sucked through slots that continue as guide vanes in the interior.

Other details and features of the invention will become apparent from the following description of one preferred embodiment using the drawings. Here:

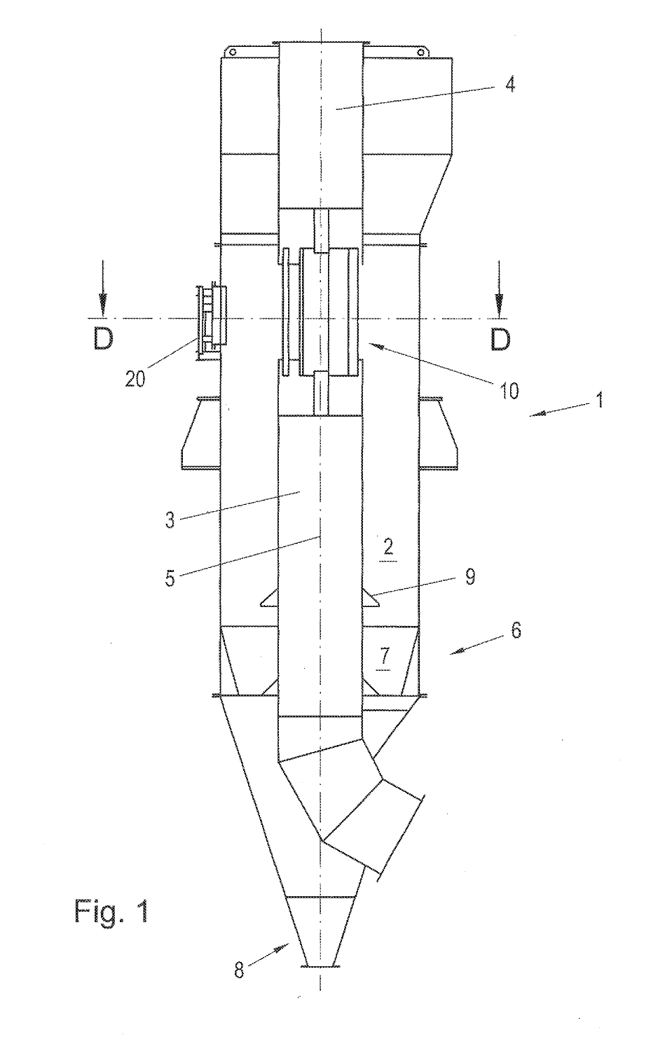

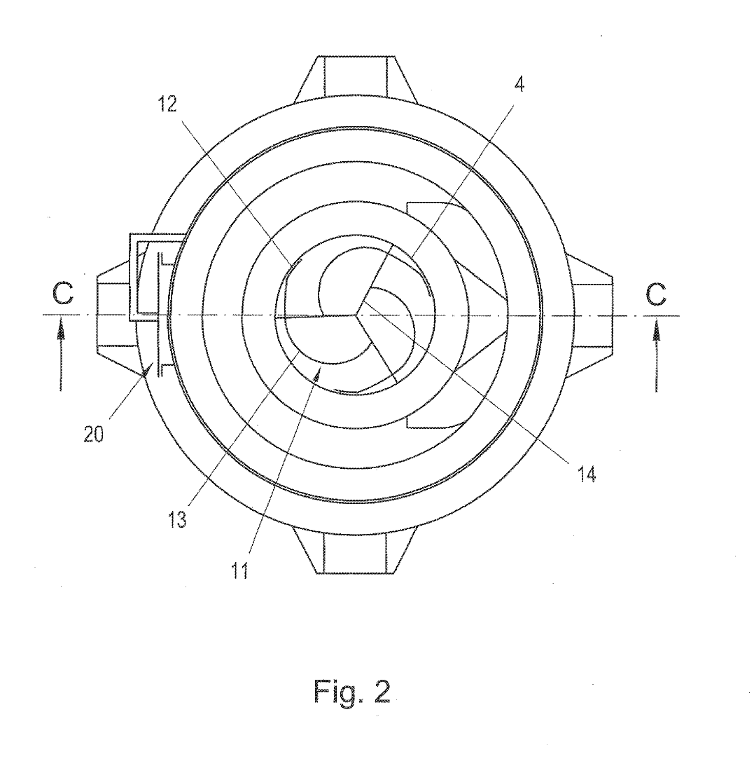

FIG. 1 shows a device according to the invention in a section along the line C-C of FIG. 2,

FIG. 2 shows a section along the line D-D of FIG. 1,

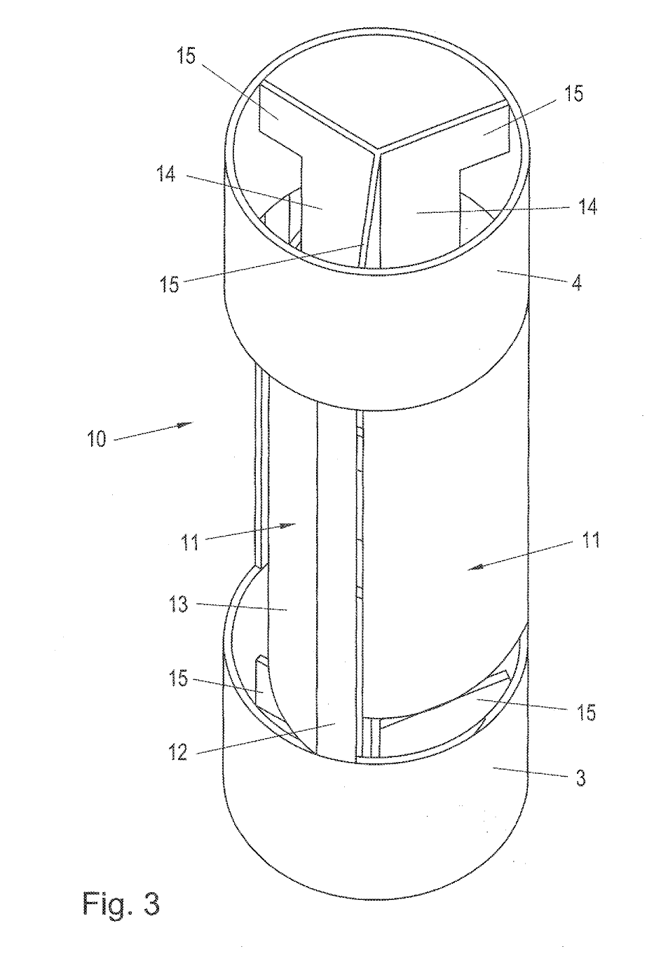

FIG. 3 shows a diffuser that is provided between the ends of the immersion tubes within the separating chamber, in an oblique view, and

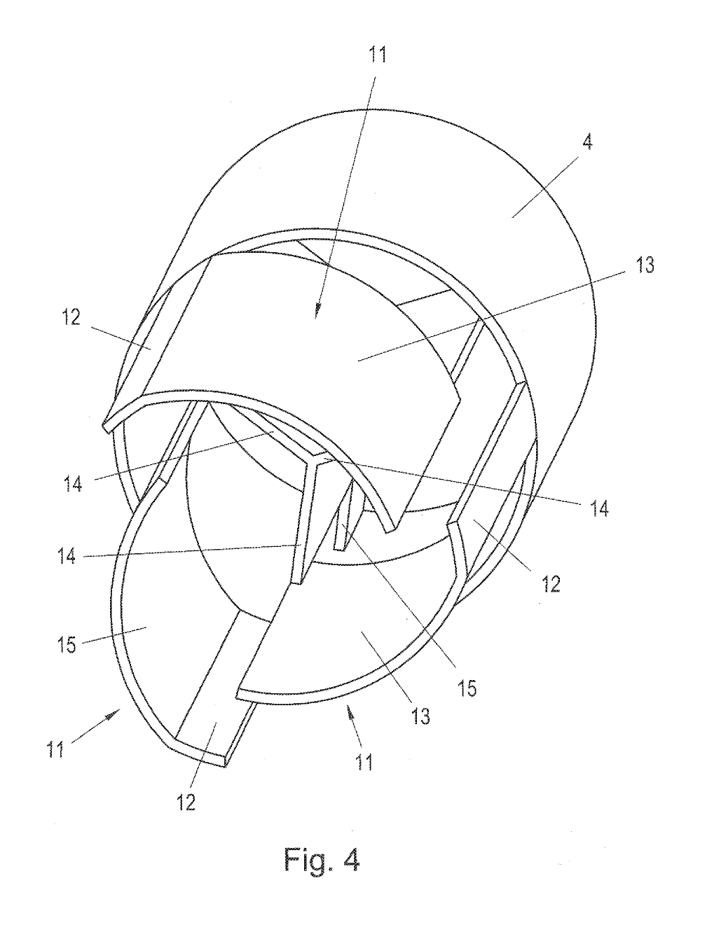

FIG. 4 shows one half of the diffuser of FIG. 3 in an oblique view.

A separating device 1 that is shown in FIGS. 1 and 2 comprises a separating chamber 2 into which two immersion tubes 3, 4 that are coaxial to one another project. A mixture of a substance and a medium to be cleaned is supplied tangentially to the separating chamber 2 in its upper region in FIG. 1 so that the mixture of the substance and the medium to be cleaned in the separating chamber 2 is set into rotation around the axis 5 of the separating chamber 2. On the lower end 6 of the separating chamber 2, there is a settling space 7 on which a discharge opening 8 for discharge of the separated substance or substances is located toward the bottom.

The separating chamber 2 is provided with an inspection and maintenance opening 20.

In the embodiment shown in FIG. 1, there is a conical channeling system 9 on the lower immersion tube 3 that prevents the substance that has already been separated from the medium from being passed upward again into the separating chamber 2 by creep flows from the settling space 7.

Between the ends of the immersion tubes 3 and 4, there is a diffuser 10 that is shown on a larger scale in FIGS. 3 and 4.

The diffuser 10 in the illustrated embodiment encompasses three guide vanes 11 that each have a section 12 that lies in the surface of the cylindrical wall of the immersion tubes 3 and 4 and a section 13 that points obliquely to the inside. Cleaned, gaseous or liquid medium, i.e., medium from which the specifically heavier substance or the specifically heavier substances have been separated, is routed into the interior of the immersion tubes 3 and 4 by the guide vanes 11 that are curved, for example curved around an axis that is parallel to the axis 5 of the immersion tubes 3 and 4, and flows through the tubes out of the device 1.

Within the guide vanes 11 of the diffuser 10, in one embodiment, there are plates 14 that act as swirl plates and that are aligned radially with respect to the axis 5 of the immersion tubes 3 and 4.

Since, in the illustrated embodiment, the diffuser 10 has three guide vanes 11 that are curved toward the inside (whose convex sides point toward the outside), there are likewise three plates 14 that act as swirl breakers. The plates 14 are connected to one another with their edges that lie in the region of the axis 8 of the device 1 and of the immersion tubes 3 and 4, and in each case point to the section 12 of the guide vanes 11 that lies in the peripheral surface of the immersion tubes 3 and 4.

The plates 14 that act as swirl breakers are supported on their ends by widened shoulders 15 on the insides of the immersion tubes 3 and 4 and are optionally connected there to the immersion tubes 3 and 4.

In the operation of the device 1 according to the invention in the embodiment shown in the drawings, the mixture of the substance and the medium to be cleaned is supplied especially tangentially to the separating chamber 2 via an inlet (not shown), which lies in the upper region of the separating chamber 2, and is set into rotary motion in the separating chamber 2 so that the specifically heavier substances (or the specifically heavier substance) are accelerated toward the outside against the wall of the separating chamber 2 and migrates [sic] through the settling space 7 to the discharge opening 8 in order to be discharged from the device 1.

The cleaned medium enters the immersion tubes 3 and 4 through the diffuser 10 (FIGS. 3 and 4) and flows through the immersion tubes 3 and 4, cleaned out of the device.

The device 1 according to the invention is an effective device that can be operated with low pressure losses and with low energy consumption, and with which at least one substance can be separated from a liquid or gaseous medium by centrifugal forces provided that the substance has a specific weight that is different from the medium.

In particular, the device according to the invention is suitable for separating mixtures of substances from at least one liquid or gaseous medium and at least one liquid or solid substance that has a higher specific weight than the medium.

In summary, one embodiment of the invention can be described as follows: A device 1 for separating at least one substance from a liquid or gaseous medium by centrifugal forces has a housing with a separating chamber 2, into which the mixture to be separated is delivered and is set into rotation. Two immersion tubes 3 and 4 through which the cleaned medium flows out project into the separating chamber 2. On the lower end of the housing, there is a discharge opening 8 for separated substance. Between the ends of the immersion tubes 3 and 4 provided within the separating chamber 1, there is a diffuser 10 that is connected to the immersion tubes 3 and 4. The diffuser 10 comprises several, especially three, curved guide vanes 11 that—viewed in the direction of rotation of the medium—have a distance increasing from the peripheral surface of the immersion tubes 3 and 4, i.e., that approach the axis 5 of the immersion tubes 3 and 4. In the diffuser 10, there are optionally plates 14 that as swirl breakers ensure a laminar flow of the cleaned medium through the immersion tubes 3 and 4 and out of the device 1.

1. Device (1) for separating a mixture of at least one liquid or gaseous medium and at least one liquid or gaseous substance that has a higher specific weight than the medium under the action of centrifugal forces, with a separating chamber (2), with a system for producing a rotary motion of the mixture around the axis (5) of the separating chamber (2), with immersion tubes (3 and 4) that project into the separating chamber (2) for withdrawal of the medium, and with a discharge opening (8) for the separated substance, between the ends of the immersion tubes (3, 4) there being a diffuser (10),
characterized in that the diffuser (10) has at least two guide vanes (11) that—relative to the direction of rotation of the mixture in the separating chamber (2)—have an increasingly shorter distance from the peripheral surface of the immersion tubes (3, 4) proceeding from the axis (5) of the immersion tubes (3 and 4).

2. Device according to claim 1, wherein the guide vanes (11) are curved around axes that are parallel to the axis (5) of the immersion tubes (3 and 4).

3. Device according to claim 2, wherein the convex sides of the guide vanes (11) point to the outside.

4. Device according to claim 1, wherein the guide vanes (11) at their root have a region (12) that lies in the surface of the immersion tubes (3 and 4).

5. Device according to claim 1, wherein there are more than two, preferably three, guide vanes (11) that are located uniformly distributed over the periphery of the diffuser (10).

6. Device according to claim 1, wherein the diffuser (10) within the guide vanes (11) has at least two plates (14) that act as swirl breakers.

7. Device according to claim 6, wherein the plates (14) are radially aligned relative to the axis (5) of the immersion tubes (3 and 4).

8. Device according to claim 6, wherein the plates (14) acting as swirl breakers are aligned radially proceeding from the axis (5) of the immersion tubes (3 and 4).

9. Device according to claim 6, wherein the plates (14) acting as swirl breakers are connected to one another in the region of their edges that lie in the axis (5) of the immersion tubes (3 and 4).

10. Device according to claim 6, wherein the plates (14) acting as swirl breakers with their ends (15) that lie above and their ends (15) that lie underneath the guide vanes (11) are supported on the inside of the immersion tubes (3 and 4) and are optionally connected there to the immersion tubes (3 and 4).

11. Device according to claim 10, wherein the ends (15) of the plates (14) have a greater width than the other middle regions of the plates (14).

12. Device according to claim 11, wherein the diffuser (10) is provided between the ends of the immersion tubes (3, 4) that lie in the separating chamber (2), connecting the tubes to one another.

13. Device according to claim 1, wherein the diffuser (10) is designed to bridge the space between the ends of the immersion tubes (3, 4) that lie in the separating chamber (2).

14. Device according to claim 2, wherein the guide vanes (11) at their root have a region (12) that lies in the surface of the immersion tubes (3 and 4).

15. Device according to claim 2, wherein the diffuser (10) within the guide vanes (11) has at least two plates (14) that act as swirl breakers.

16. Device according to claim 7, wherein the plates (14) acting as swirl breakers are aligned radially proceeding from the axis (5) of the immersion tubes (3 and 4).
